(19) United States
(12) Patent Application Publication
(10) Pub. No.: US 2011/0126613 A1
(43) Pub. Date: Jun. 2, 2011

(54) WATERPROOF ELECTRONIC DEVICE WITH TEST STRUCTURE AND WATER-LEAK TEST FIXTURE AND METHOD THEREOF

(75) Inventors: YU-FANG LIN, Taipei (TW); HSIEN-MING LEE, Taipei (TW); WEI-KER KUO, Taipei (TW)

(73) Assignee: ABILITY ENTERPRISE CO., LTD., Taipei (TW)

(21) Appl. No.: 12/792,697

(22) Filed: Jun. 2, 2010

(30) Foreign Application Priority Data
Dec. 2, 2009 (TW) 098141126

(51) Int. Cl. G01M 3/04

(52) U.S. Cl. 73/40

(57) ABSTRACT

The present invention is directed to a waterproof electronic device with a test structure, including a test opening, a sealing structure and a fixation structure. The test opening is arranged on a housing of the waterproof electronic device, and is used for injecting a test fluid for detecting water leak. The sealing structure is arranged on the housing or a test fixture, and is used for holding a sealing element such that the waterproof electronic device and the test fixture may be sealed to each other when performing a leak test. The fixation structure is used for fixing the test fixture on the waterproof electronic device.

### CROSS-REFERENCE TO RELATED APPLICATIONS

The entire contents of Taiwan Patent Application No. 098141126, filed on Dec. 2, 2009, from which this application claims priority, are incorporated herein by reference.

### BACKGROUND OF THE INVENTION

1. Field of the Invention

The present invention generally relates to a waterproof electronic device, and more particularly to a waterproof electronic device with test structure, which may be cooperated with a water-leak test fixture for performing a water-leak test.

2. Description of Related Art

Digital cameras or camcorders are becoming essential tools for people. As their application range becomes broader, more specifications are demanded by people. Among those specifications, waterproofing allows the digital cameras or camcorders to be adaptable to bad weather or operable underwater. A watertight housing is fundamental to waterproof digital cameras or camcorders. However, as the digital cameras or camcorders nowadays have weak structure due to their lightweight, thin and small requirements, it becomes difficult for them to resist water leak.

A waterproof digital camera or camcorder may encounter water-leak problem either during a development stage, a production stage or a user operation stage. Once the water-leak problem occurs, the most important and hardest part is to find out where the water leaks. Even though there is conventionally provided a water-leak test during the development stage, there is no way to test water leak, not to mention to modify or fill up the deficiency, during the mass production stage or after the digital cameras or camcorders have been sold to users. Furthermore, most conventional water-leak tests are destructive methods, which oftentimes damage the housing of the digital cameras or camcorders. In other words, one digital camera or camcorder need be thrown away after each water-leak test. Accordingly, those destructive methods may be adaptable only in the development stage, but not in the user operation stage.

For the reason that there is no conventional effective water-leak test and associated fixture for the waterproof camera or camcorder, a need has arisen to propose a novel scheme for performing a water-leak test adaptable in the development stage, the production stage and the operation state.

### SUMMARY OF THE INVENTION

In view of the foregoing, it is an object of the embodiment of the present invention to provide a waterproof electronic device with a test structure, a water-leak test fixture and a test method for adaptively performing water-leak test during a development stage, a production stage, or after purchase, in order to effectively and fast find out where the water leaks, what the cause of the leak is, and what a remedy may be.

According to one embodiment of the present invention, a waterproof electronic device with a test structure mainly includes a test opening, a sealing structure and a fixation structure. The test opening is arranged on a housing of the waterproof electronic device, and is used for injecting test fluid to detect water leak. The sealing structure is arranged on the housing or a test fixture, and is used for holding a sealing element such that the waterproof electronic device and the test fixture may be sealed to each other when performing a leak test. The fixation structure is used for fixing the test fixture on the waterproof electronic device

According to another embodiment of the present invention, a water-leak test fixture adaptable to a waterproof electronic device primary includes a passage housing and a fixation component. The passage housing provides a fluid passage, where the first port of the passage housing is provided to inject test fluid, and the second port of the passage housing allows the test fluid to inject into the waterproof electronic device via a test opening of the waterproof electronic device. The fixation component is connected to the second port of the passage housing for allowing the water-leak test fixture to fix on the waterproof electronic device when performing a water-leak test.

According to a further embodiment of the present invention, a water-leak test method adaptable to a waterproof electronic device is disclosed. Firstly, a pressure-sealed chamber is provided with initial pressure higher than atmospheric pressure. The waterproof electronic device is placed in the pressure-sealed chamber and held for a predetermined period of time. After the predetermined period of time has elapsed, detect to determine whether a pressure value of the pressure-sealed chamber drops to a value lower than predetermined threshold pressure. If the pressure value is lower than the predetermined threshold pressure, test fluid is injected into the waterproof electronic device via a test hole of the waterproof electronic device after the waterproof electronic device is removed from the pressure-sealed chamber. Subsequently, observe to find out where the test fluid leaks from the waterproof electronic device.

### BRIEF DESCRIPTION OF THE DRAWINGS

FIG. 1A shows a top view of a waterproof electronic device with a test structure according to one embodiment of the present invention;

FIG. 1B shows a sectional side view along a section line 1B-1B′ in FIG. 1A;

FIG. 1C shows an enlarged view encircled by a dashed line 1C in FIG. 1B;

FIGS. 1D-1E respectively show test structures according to other embodiments of the present invention;

FIG. 2A shows a perspective view of a water-leak test fixture adaptable to the waterproof electronic device according to one embodiment of the present invention;

FIG. 2B shows a sectional side view of the water-leak test fixture fixed onto the housing of the waterproof electric device;

FIGS. 2C-2F respectively show sectional side views of water-leak test fixtures according to other embodiments of the present invention; and

FIG. 3 shows a flow diagram of a water-leak test method adaptable to the waterproof electric device according to one embodiment of the present invention.

### DETAILED DESCRIPTION OF THE INVENTION

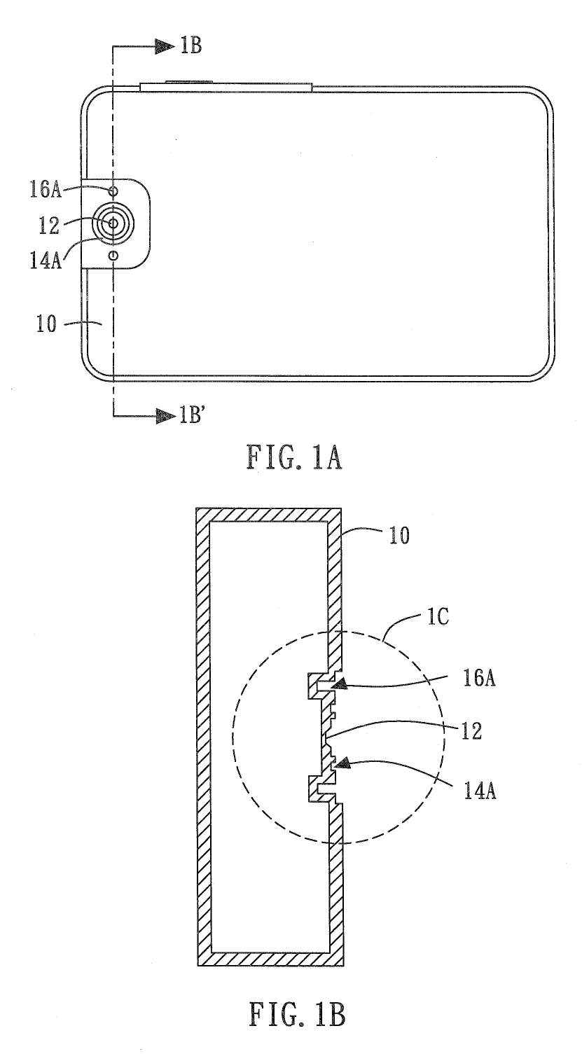

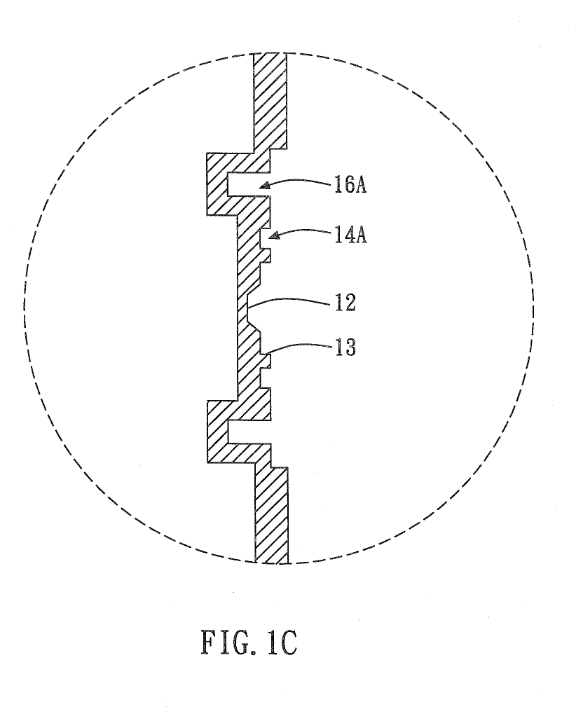

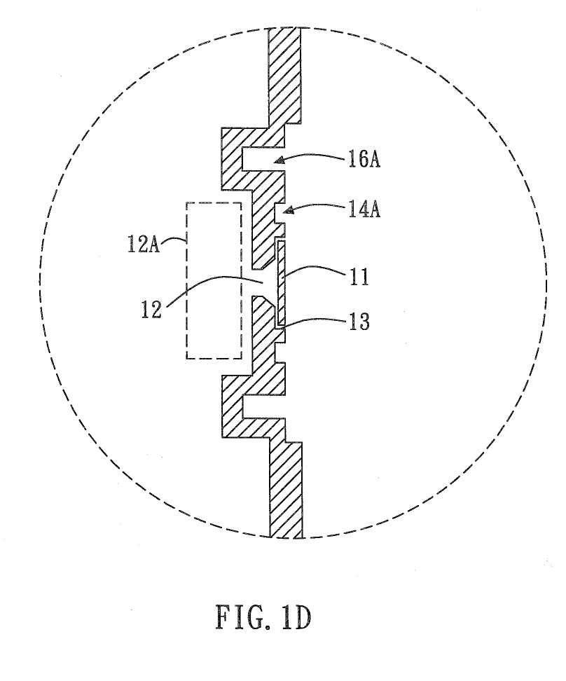

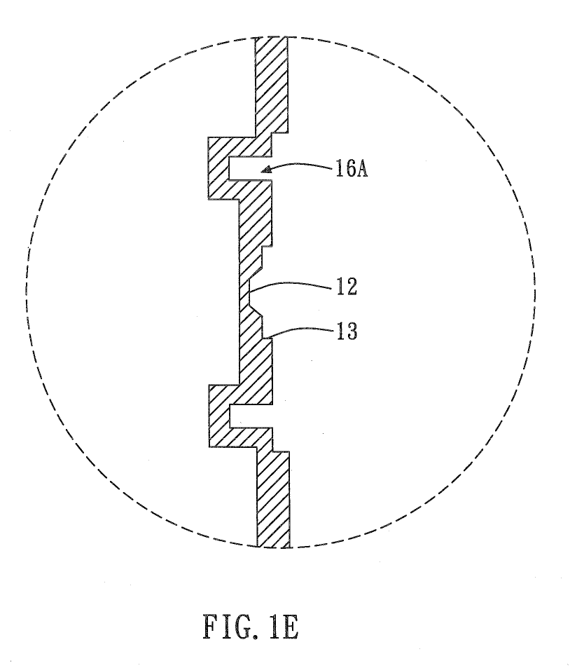

FIG. 1A shows a top view of a waterproof electronic device with a test structure according to one embodiment of the present invention. FIG. 1B shows a sectional side view along a section line 1B-1B′, and FIG. 1C shows an enlarged view encircled by a dashed line 1C in FIG. 1B. In order to make aspects of the present embodiment eminent, only the structures related to the present embodiment are depicted while omitting other structures on and inside a housing 10 of the waterproof electronic device. In the embodiment, the waterproof electronic device may be a digital camera or a camcorder. However, the present embodiment may also be adaptable to other electronic devices.

In the embodiment, the test structure of the waterproof electronic device is used for testing water leak. The test structure mainly includes a test opening 12 arranged on a surface of the housing 10. The test opening 12 is used for injecting test fluid (that is, gas or liquid) to perform the water-leak test. How the test fluid is injected and how the water-leak test is performed will be described in details later in this specification. As shown in FIG. 1B or FIG. 1C, the test opening 12 does not pass through the housing 10 until when the water-leak test is to be performed. However, in other embodiments, the test opening 12 may pass through the housing 10 when the housing 10 is manufactured. One test opening 12 is used in the embodiment; however, the number of the test openings may be greater than one according to specific demands. In addition, the shape of the test opening 12 may be, but not limited to, a circle as in the embodiment.

FIG. 1D shows a test structure according to another embodiment of the present invention. In the embodiment, the test opening 12 is a microphone hole that is associated with a microphone device 12A. Moreover, waterproof breathable fabric 11 is used in the embodiment, and the waterproof breathable fabric 11 may be a circle in shape and have a size approximately equal to that of a groove 13 surrounding the test opening 12. The waterproof breathable fabric 11 is made of a material that allows gas molecule to pass through but block water molecule. The waterproof breathable fabric 11 may be embedded into the groove 13 to cover the test opening 12 such that water can not pass through the test opening 12 when the waterproof electronic device is operated. However, the waterproof breathable fabric 11 may be disposed inside the housing 10.

A sealing structure 14A is arranged surrounding the test opening 12 for holding a sealing element (not shown in FIGS. 1A-1D), which may be a gasket, such as an O-ring. In the embodiment, the sealing structure 14A may be, but not limited to, a closed groove, and its shape may be, but not limited to, a circle as depicted in the figure. The waterproof electronic device and a water-leak test fixture (not shown in FIGS. 1A-1D) may be sealed to each other when performing the water-leak test. The sealing element and the water-leak test fixture will be described in details later in this specification. In another embodiment, as shown FIG. 1E, the sealing structure 14A is not arranged on the hosing 10, but arranged on the water-leak test fixture. As a result, the housing 10 may have a flatter surface and have larger usable space.

The test structure of the waterproof electronic device may further include a fixation structure 16A arranged surrounding the test opening 12 and the sealing structure 14A. The fixation structure 16A may be used to fix the water-leak test fixture onto the waterproof electronic device when performing the water-leak test. In the embodiment, the fixation structure 16A includes one or more screw holes, which are cooperative with screws to fix the water-leak test fixture onto the waterproof electronic device. However, in other embodiments, other fixation mechanisms may be used instead of the screws/screw holes. In the embodiment, inner walls of the fixation structure 16A have no screw thread. The screw thread will be formed on the inner wall when the screw is screwed into the screw hole.

Before performing the water-leak test, waterproof breathable fabric 11 (as shown in FIG. 1D) may be used to cover a through test opening 12 in order to prevent water from entering into the waterproof electronic device.

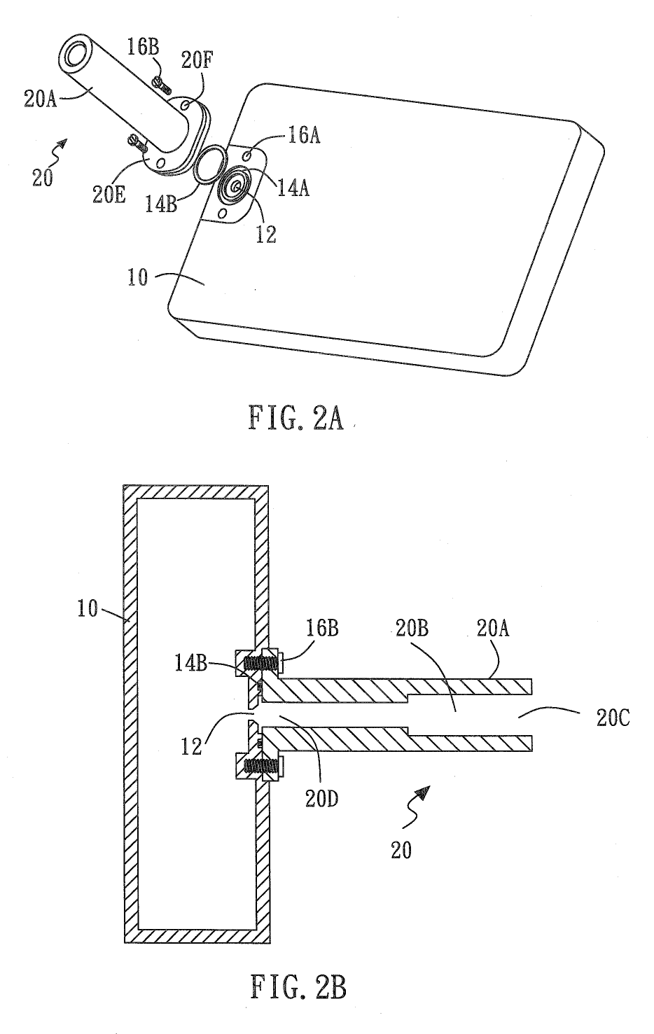

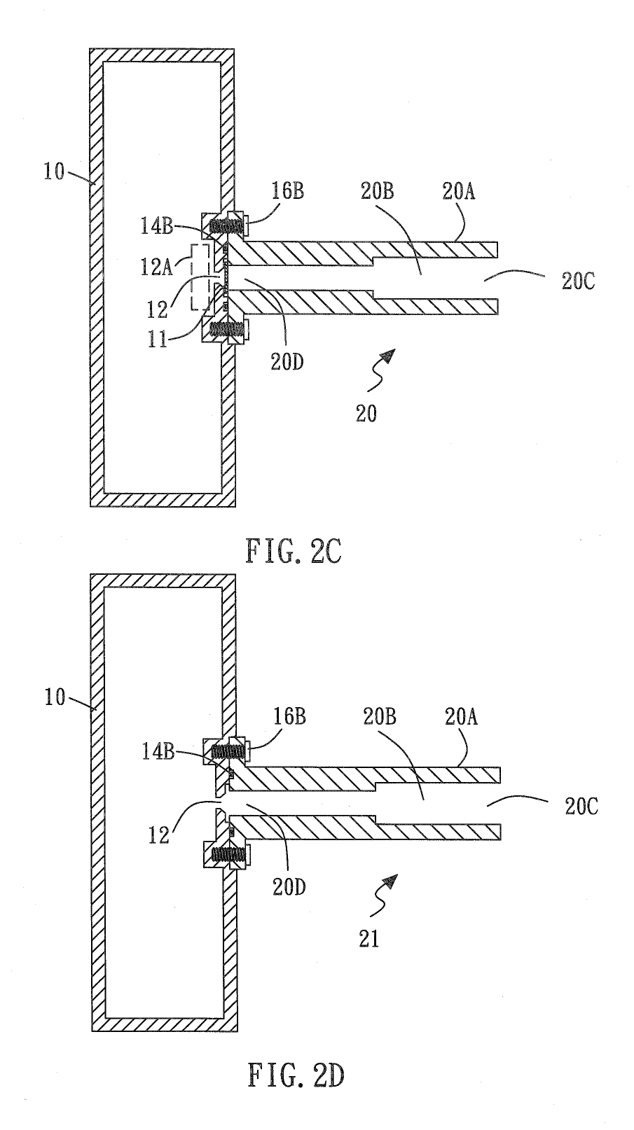

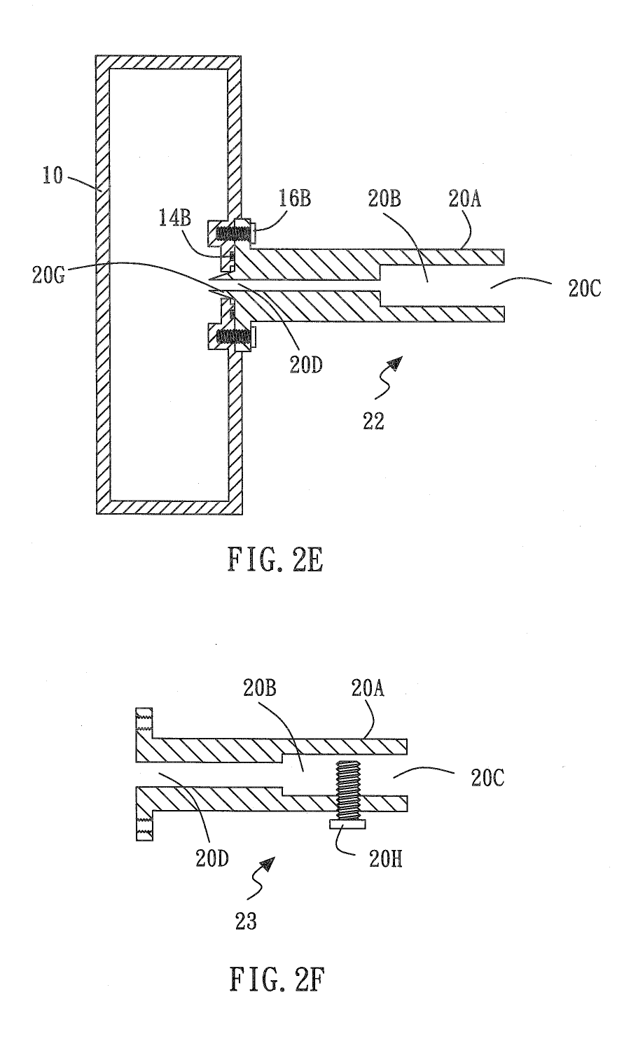

FIG. 2A shows a perspective view of a water-leak test fixture adaptable to the waterproof electronic device 20, as well as the sealing element 14B (for example, the O-ring) according to one embodiment of the present invention. FIG. 2B shows a sectional side view of the water-leak test fixture 20 fixed on the housing 10 of the waterproof electronic device. In the embodiment, the water-leak test fixture 20 mainly includes a passage housing 20A, inside which a fluid passage 20B is provided. The first port 20C of the passage housing 20A is provided to inject the test fluid. The second port 20D of the passage housing 20A allows the test fluid to be injected, via the test opening 12, into the housing 10 of the waterproof electronic device. Additionally, the water-leak test fixture 20B further includes a fixation component 20E, for example, a flat panel perpendicular to the fluid passage 20B, to be connected to the second port 20D of the passage housing 20A. When performing the water-leak test, firstly, a through test opening 12 is formed and is covered by the waterproof breathable fabric 11. Subsequently, the screw 16B is screwed into the fixation structure 16A (e.g., screw hole) via a threaded hole 20F of the fixation component 20E in order to fix the water-fixture test fixture 20 onto the housing 10 of the waterproof electronic device.

FIG. 2C shows another configuration of using the water-leak test fixture 20 according to another embodiment of the present invention. In the embodiment, the test opening 12 is a microphone hole that is associated with a microphone device 12A. In addition, the waterproof breathable fabric 11 is used to cover the test opening 12.

FIG. 2D shows a sectional side view of a water-leak test fixture 21 according to another embodiment of the present invention. The structure of the water-leak test fixture 21 of the present embodiment is similar to that of the water-leak test fixture 20 as shown in FIGS. 2A-2B, except that the sealing structure 14A is arranged on the water-leak test fixture 21.

FIG. 2E shows a sectional side view of a water-leak test fixture 22 according to a further embodiment of the present invention. The water-leak test fixture 22 of the present embodiment is similar to the water-leak test fixture 20 as shown in FIGS. 2A-2B, except that protruding ends 20G are added at the second port 20D of the passage housing 20A of the water-leak test fixture 22. The through test opening 12 is formed by the protruding ends 20G when performing the water-leak test.

FIG. 2F shows a sectional side view of a water-leak test fixture 23 according to a further embodiment of the present invention. The water-leak test fixture 23 of the present embodiment is similar to the water-leak test fixture 20 as shown in FIGS. 2A-2B, except that a regulating valve 20H is added at the first port 20C of the passage housing 20A of the water-test test fixture 23 for regulating the flow of test fluid through the fluid passage 20B.

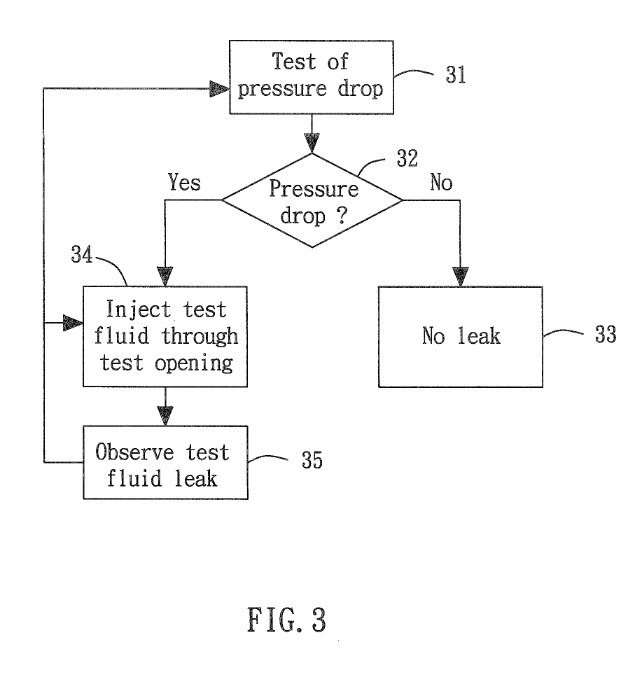

In accordance with the test structure of the waterproof electronic device and the water-leak test fixture 20/21/22/23 as described above, the water-leak test may be performed on the waterproof electronic device. FIG. 3 shows a flow diagram of a water-leak test method adaptable to the waterproof electronic device according to one embodiment of the present invention. Firstly, a test of pressure drop is performed in step 31. Specifically, the waterproof electronic device is held in a pressure-sealed chamber for a predetermined period of time. The initial pressure of the pressure-sealed chamber is preferably higher than atmospheric pressure. After the predetermined period of time has elapsed, the pressure of the pressure-sealed chamber is detected to determine whether the pressure drops (step 32), for example, whether it drops to a pressure value lower than predetermined threshold pressure. The waterproof electronic device is determined as being not leaky (step 33) if no pressure drop occurs. On the other hand, the waterproof electronic device is removed from the pressure-sealed chamber if pressure drop occurs, and the water-leak test fixture 20/21/22/23 as described above is then fixed to the test structure of the waterproof electronic device. Subsequently, test fluid is injected from the first port of the water-leak test fixture 20/21/22/23, then passes through the test opening 12, and finally enters into the housing 10 of the waterproof electronic device (step 34). The test opening 12 is punched to make a through test opening before step 34, if the test opening 12 does not pass through the housing 10 beforehand. In step 35, observe to find out where the test fluid leaks from the housing 10 of the waterproof electronic device. The leakage location may then be filled, or the housing 10 may be modified or redesigned. After performing the filling or modification, the test of pressure drop (step 31) or the test fluid injection (step 34) may be performed again until no leakage is finally assured.

According to one embodiment, the injected test fluid may be gas (for example, the common air) (in step 34). Before, during or after the gas is injected in the embodiment, the waterproof electronic device is placed into water for observing to find out where air bubbles leak (step 35).

According to another embodiment, the test fluid may be light sensitive agent (e.g., ultraviolet (UV) sensitive agent) (in step 34). In the embodiment, the waterproof electronic device need not be put into the water. Instead, a detector (e.g., US detector) is utilized to observe to find out where light sensitive agent leaks (step 35).

The embodiments as described above may be adaptable in any stage (for example, development stage, production stage, or operation stage) to find out the cause of the water leak. For example, in the development stage, locating the water leak may facilitate recognizing deficiency in mold design, material used or assembly, thereby saving substantive time in the development stage. In the production stage, locating the water leak may facilitate improving the deficiency in time in order to prevent product repair, refund or recall in the future. After the products have been sold, locating the water leak may facilitate understanding the cause of the water leak to be structural damage or improper usage.

Although specific embodiments have been illustrated and described, it will be appreciated by those skilled in the art that various modifications may be made without departing from the scope of the present invention, which is intended to be limited solely by the appended claims.

What is claimed is:

1. A waterproof electronic device with a test structure, comprising:
a test opening arranged on a housing of the waterproof electronic device for injecting test fluid to perform a water-leak test; and
a fixation structure for fixing a water-leak test fixture on the waterproof electronic device when performing the water-leak test.

2. The waterproof electronic device of claim 1, wherein the waterproof electronic device is a digital camera or a camcorder.

3. The waterproof electronic device of claim 1, further comprising a sealing structure arranged on the housing or the test fixture for holding a sealing element such that the waterproof electronic device and the test fixture are sealed to each other when performing the water-leak test.

4. The waterproof electronic device of claim 1, wherein the test opening is a microphone hole.

5. The waterproof electronic device of claim 1, wherein the test opening does not pass through the housing, the test opening being punched through when performing the water-leak test.

6. The waterproof electronic device of claim 1, further comprising:
waterproof breathable fabric for covering the test opening.

7. The waterproof electronic device of claim 6, further comprising a groove arranged surrounding the test opening for holding the waterproof breathable fabric.

8. The waterproof electronic device of claim 3, wherein the sealing element is an O-ring.

9. The waterproof electronic device of claim 1, wherein the fixation structure comprises a plurality of screw holes, into which a plurality of screws are screwed to fix the water-leak test fixture on the waterproof electronic device.

10. A water-leak test fixture adaptable to a waterproof electronic device, comprising:
a passage housing for providing a fluid passage, a first port of the passage housing being for injecting test fluid, and a second port of the passage housing allowing the test fluid to inject into the waterproof electronic device via a test opening of the waterproof electronic device; and
a fixation component connected to the second port of the passage housing for allowing the water-leak test fixture to fix on the waterproof electronic device when performing a water-leak test.

11. The water-leak test fixture of claim 10, wherein the second port of the passage housing further comprises at least one groove, which is used for holding a sealing element when performing the water-leak test.

12. The water-leak test fixture of claim 10, wherein the second port of the passage housing further comprises at least one protruding end, which is used for punching the test opening when performing the water-leak test.

13. The water-leak test fixture of claim 10, further comprising a regulating valve arranged at the first port of the passage housing for regulating flow of the test fluid through the fluid passage.

14. A water-leak test method adaptable to a waterproof electronic device, comprising:
providing a pressure-sealed chamber, wherein initial pressure of the pressure-sealed chamber is higher than atmospheric pressure;
placing the waterproof electronic device in the pressure-sealed chamber for a predetermined period of time;
detecting to determine whether a pressure value of the pressure-sealed chamber drops to a value lower than predetermined threshold pressure after the predetermined period of time has elapsed;
if the pressure value is lower than the predetermined threshold pressure, injecting test fluid into the waterproof electronic device via a test hole of the waterproof electronic device after the waterproof electronic device is removed from the pressure-sealed chamber; and
observing to find out where the test fluid leaks from a housing of the waterproof electronic device.

15. The method of claim 14, wherein the waterproof electronic device is a digital camera or a camcorder.

16. The method of claim 14, before injecting the test fluid, further comprising:
punching the test opening to pass through the housing.

17. The method of claim 14, wherein the test fluid comprises test gas.

18. The method of claim 17, further comprising:
placing the waterproof electronic device in the water for observing air bubbles leaking from the waterproof electronic device.

19. The method of claim 14, wherein the test fluid comprises light sensitive agent.

20. The method of claim 19, further comprising:
using a detector to observe the light sensitive agent leaking from the waterproof electronic device.
